(19) United States
(12) Patent Application Publication
(10) Pub. No.: US 2007/0017168 A1
(43) Pub. Date: Jan. 25, 2007

(54) Dual panel apparatus

(75) Inventor: Jae Do Lee, Gumi-shi (KR)

Correspondence Address: FLESHNER & KIM, LLP, P.O. BOX 221200, CHANTILLY, VA, 20153, US

(73) Assignee: LG Electronics Inc.

(21) Appl. No.: 11/405,433

(22) Filed: Apr. 18, 2006

(30) Foreign Application Priority Data
Jun. 22, 2005 (KR) 10-2005-0053998

(51) Int. Cl. E06B 7/00; E04C 2/54

(52) U.S. Cl. 52/171.1; 52/783.1

(57) ABSTRACT

The present invention relates to a dual panel apparatus in which a data driver is located between a first panel and a second panel. The dual panel apparatus includes a first panel, a second panel, and a driver. The first panel has first pixels. The second panel has second pixels. The driver is coupled to the first panel and the second panel, and drives selectively the first panel and the second panel. The dual panel apparatus of the present invention drives selectively a first panel and a second panel by using a data driver located between the panels, and thus the size of the dual panel is reduced.

### BACKGROUND OF THE INVENTION

1. Field of the Invention

The present invention relates to a dual panel apparatus. Particularly, the present invention relates to a dual panel apparatus in which a data driver is located between a first panel and a second panel.

2. Description of the Related Art

A dual panel apparatus means an apparatus for employing two panels, i.e. main panel and sub panel. One example of the dual panel apparatus is a mobile phone.

A dual panel apparatus in the art employs a liquid crystal display (LCD) as main panel, and an organic electroluminescent panel as sub panel. Hence, the dual panel apparatus should have included separately a first driver for driving the LCD and a second driver for driving the organic electroluminescent device. Accordingly, the size of the dual panel apparatus could not but be increased.

In addition, the manufacturing cost of the LCD is higher than that of the organic electroluminescent panel, and so the cost of the dual panel apparatus is increased. Accordingly, a dual panel apparatus with smaller size and less manufacturing cost has been required.

### SUMMARY OF THE INVENTION

It is a feature of the present invention to provide a dual panel apparatus for employing two organic electroluminescent panels.

It is another feature of the present invention to provide a dual panel apparatus in which a data driver is located between a stack-typed first panel and a stripe-typed second panel.

A dual panel apparatus according to one embodiment of the present invention includes a first panel, a second panel, and a driver. The first panel has first pixels. The second panel has second pixels. The driver is coupled to the first panel and the second panel, and drives selectively the first panel and the second panel.

A dual panel apparatus according to another embodiment of the present invention includes first anode electrode layers, first cathode electrode layers, first pixels, second anode electrode layers, second cathode electrode layers, second pixels, and a data driver. The first anode electrode layers are disposed in a first direction. The first cathode electrode layers are disposed in a second direction different from the first direction. The first pixels are formed in cross areas of the first anode electrode layers and the first cathode electrode layers. The second anode electrode layers are disposed in a third direction. The second cathode electrode layers are disposed in a fourth direction different from the third direction. The second pixels are formed in cross areas of the second anode electrode layers and the second cathode electrode layers. The data driver is coupled selectively to the first anode electrode layers and the second anode electrode layers, and transmits corresponding data signals to the coupled anode electrode layers.

A dual panel apparatus according to still another embodiment of the present invention includes first data lines, first scan lines, first pixels, second data lines, second scan lines, second pixels, a first scan driving circuit, a second scan driving circuit, and a data driving circuit. The first data lines are disposed in a first direction. The first scan lines are disposed in a second direction different from the first direction. The first pixels are formed in cross areas of the first data lines and the first scan lines. The second data lines are disposed in a third direction. The second scan lines are disposed in a fourth direction different from the third direction. The second pixels are formed in cross areas of the second data lines and the second scan lines. The first scan driving circuit transmits first scan signal to at least one first scan line. The second scan driving circuit transmits second scan signal to at least one scan line. The data driving circuit provides selectively corresponding data signal to at least one first data line and at least one second data line.

As described above, a dual panel apparatus according to one embodiment of the present invention drives selectively a first panel and a second panel by using a data driver located between the panels, and thus the size of the dual panel can be reduced.

In addition, a dual panel apparatus according to another embodiment of the present invention uses a stack-typed panel as main panel, and so is suitable to a large size panel.

Further, a dual panel apparatus according to still another embodiment of the present invention uses two organic electroluminescent panels as main panel and sub panel, and thus the unit cost of the dual panel apparatus can be reduced.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plan view illustrating a dual panel apparatus according to a first embodiment of the present invention;

FIG. 2 is a view illustrating a circuitry of the dual panel apparatus of FIG. 1 according to one embodiment of the present invention;

FIG. 3 is a plan view illustrating a dual panel apparatus according to a second embodiment of the present invention; and

FIG. 4 is a view illustrating a circuitry of the dual panel apparatus in FIG. 3 according to one embodiment of the present invention.

### DESCRIPTION OF EMBODIMENTS

Hereinafter, preferred embodiments of the present invention will be explained in more detail with reference to the accompanying drawings.

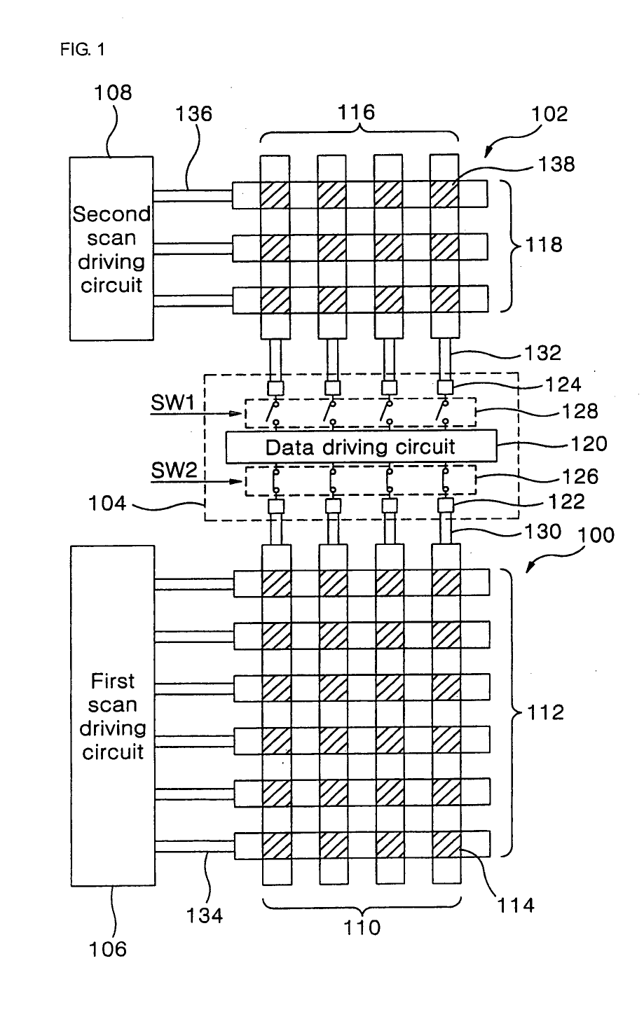

FIG. 1 is a plan view illustrating a dual panel apparatus according to a first embodiment of the present invention.

In FIG. 1, the dual panel apparatus of the present invention includes a first panel 100, a second panel 102, a data driver 104, a scan driving circuit 106, and a second scan driving circuit 108.

Each of the panels 100 and 102 according to one embodiment of the present invention is organic electroluminescent panel, and is employed, for example, for a mobile phone.

The first panel 100 as main panel includes a plurality of first sub pixels 114 formed in cross areas of first anode electrode layers 110 and first cathode electrode layers 112.

The second panel 102 as sub panel includes a plurality of second sub pixels 138 formed in cross areas of second anode electrode layers 116 and second cathode electrode layers 118. Here, each of the panels 100 and 102 is a stripe-typed panel.

The data driver 104 is located between the first panel 100 and the second panel 102, and includes a data driving circuit 120, first pads 122, second pads 124, a first switching circuit 126, and a second switching circuit 128.

The first pads 122 are coupled to the first anode electrode layers 110 through first data lines 130.

The second pads 124 are coupled to the second anode electrode layers 116 through second data lines 132.

The data driving circuit 120 transmits first data signals to the first anode electrode layers 110 through the first pads 122 and the first data lines 130.

In addition, the data driving circuit 120 transmits second data signals to the second anode electrode layers 116 through the second pads 124 and the second data lines 132.

The first switching circuit 126 includes a plurality of first switches for switching couple of the data driving circuit 120 and the first pads 122.

The second switching circuit 128 includes a plurality of second switches for switching couple of the data driving circuit 120 and the second pads 124.

The first switches are switched depending on first switching signal (SW1), and the second switches are switched depending on second switching signal (SW2). Here, the second switching signal (SW2) is an inverting signal of the first switching signal (SW1). Hence, in case that the first switches are turned on, the second switches are turned off. In this case, the data driving circuit 120 transmits the first data signals to the first anode electrode layers 110, and thus the first panel 100 displays an image corresponding to the first data signals.

Alternatively, in case that the first switches are turned off, the second switches are turned on. In this case, the data driving circuit 120 transmits the second data signals to the second anode electrode layers 116, and so the second panel 102 displays an image corresponding to the second data signals.

In other words, the data driving circuit 120 is coupled to one of the first pads 122 and the second pads 124, and so only one of the panels 100 and 102 displays a certain image.

The first scan driving circuit 106 transmits first scan signals to the first cathode electrode layers 112 through first scan lines 134.

The second scan driving circuit 108 transmits second scan signals to the second cathode electrode layers 118 through second scan lines 136.

As described above, the dual panel apparatus of the present invention is located between the first panel 100 and the second panel 102, and operates only one of the panels 100 and 102 by controlling the first and second switches.

Unlike a dual panel apparatus in the Related Art using two data driving circuits, the dual panel apparatus of the present invention may drive selectively the first panel 100 and the second panel 102 by using the data driving circuit 120. Accordingly, the dual panel apparatus of the present invention may have smaller size than one in the Related Art, and thus is suitable for a mobile phone.

In particular, in case that a user displays a certain image by using a main panel of the mobile phone, the mobile phone turns off its sub panel in order to reduce consumption of a battery. However, in case that the user displays a certain image by using the sub panel of the mobile phone, the mobile phone turns off the main panel. In other words, the mobile phone drives selectively the panels, and thus the dual panel apparatus of the present invention for driving selectively the panels 100 and 102 is suitable for the mobile phone.

In a dual panel apparatus according to another embodiment of the present invention, the number of first anode electrode layers of first panel may be more than that of second anode electrode layers of second panel.

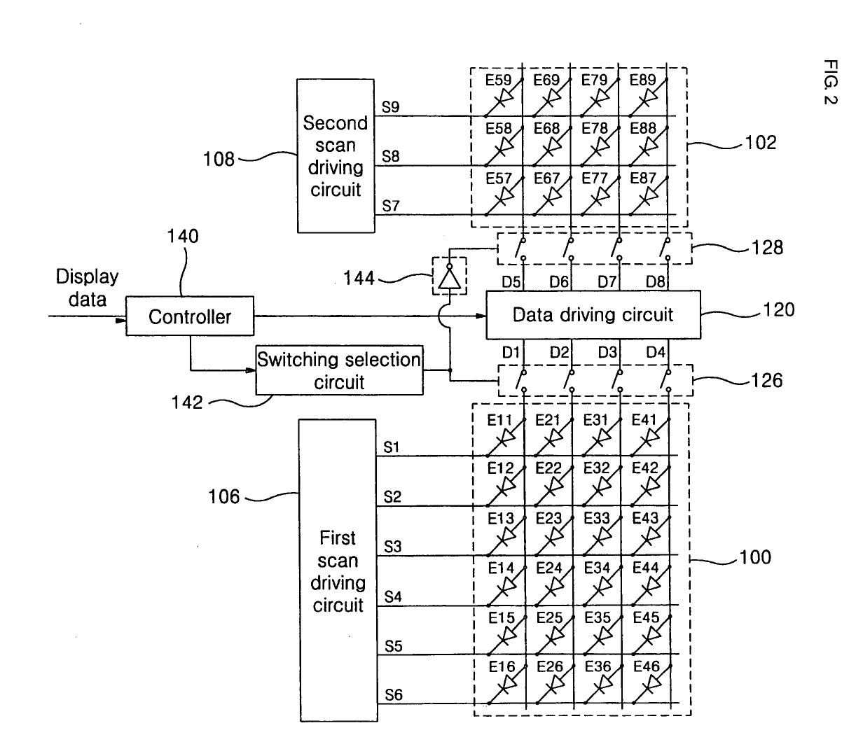

FIG. 2 is a view illustrating a circuitry of the dual panel apparatus of FIG. 1 according to one embodiment of the present invention.

In FIG. 2, the dual panel apparatus of the present invention includes a first panel 100, a second panel 102, a first scan driving circuit 106, a second scan driving circuit 108, a first switching circuit 126, a second switching circuit 128, a controller 140, a switching selection circuit 142, and an inverting section 144.

The first scan driving circuit 106 transmits the first scan signals to first sub pixels E11 to E46 through first scan lines S1 to S6.

The second scan driving circuit 108 transmits the second scan signals to second sub pixels E57 to E89 through second scan lines S7 to S9.

The controller 140 receives first display data and second display data from an outside apparatus, and controls the scan driving circuits 106 and 108, the switching circuits 126 and 128, and the switching selection circuit 142 by using the received display data. Here, the first display data indicate data corresponding to an image displayed on the first panel 100, and the second display data mean data corresponding to an image displayed on the second panel 102.

The switching selection circuit 142 switches first switches in the first switching circuit 126 and second switches in the second switching circuit 128. Here, the switching selection circuit 142 turns on the first switches or the second switches.

For example, when only the first switches are turned on, the data driving circuit 120 transmits the first data signals, i.e. first data current corresponding to the first display data transmitted from the controller 140 to the first sub pixels E11 to E46 through the first data lines D1 to D4. As a result, the first panel 100 displays the image corresponding to the first display data.

And, when only the second switches are turned on, the data driving circuit 120 transmits the second data signals, i.e. second data current corresponding to the second display data transmitted from the controller 140 to the second sub pixels E57 to E89 through the second data lines D5 to D8. As a result, the second panel 102 displays the image corresponding to the second display data.

In short, the dual panel apparatus of the present invention drives selectively the first panel 100 and the second panel 102 through one data driving circuit 120 located between the first panel 100 and the second panel 102.

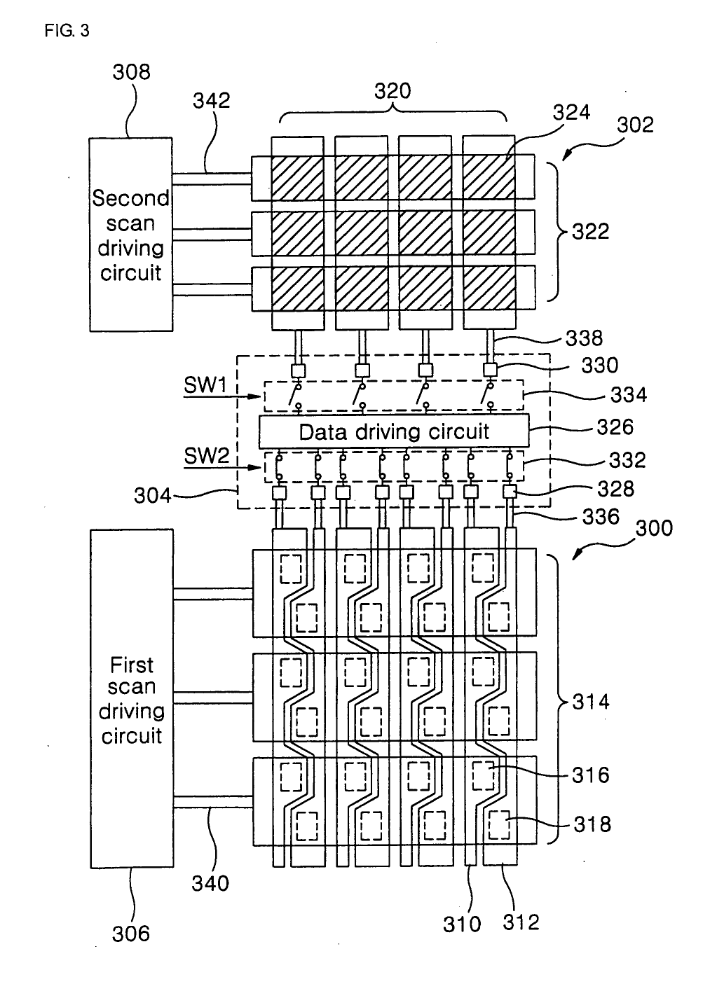

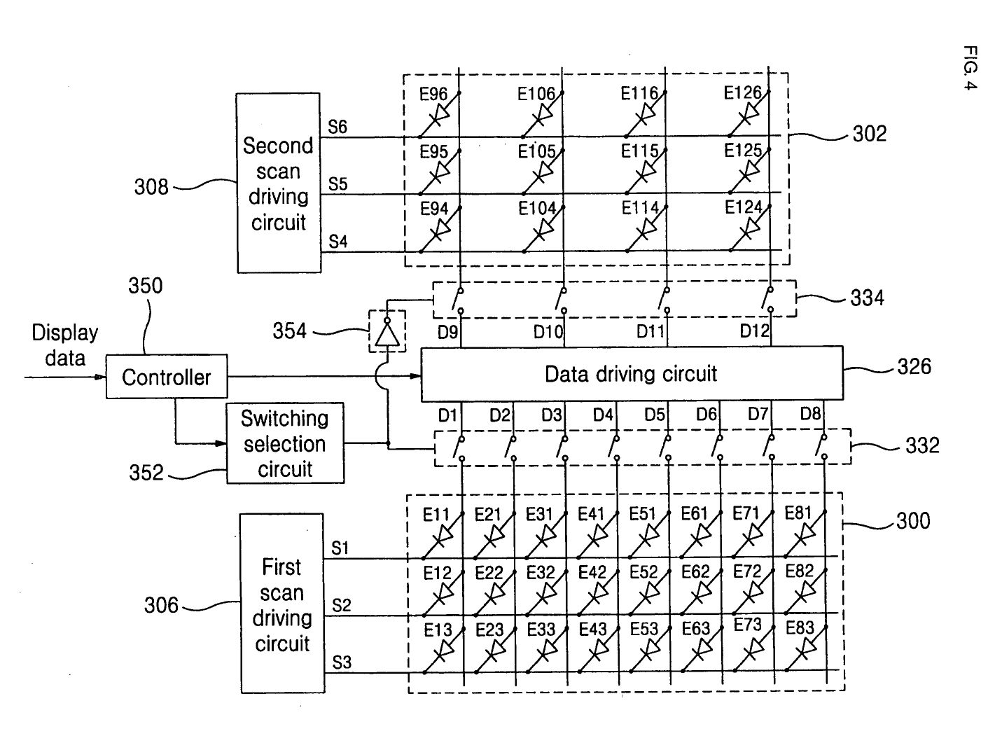

FIG. 3 is a plan view illustrating a dual panel apparatus according to a second embodiment of the present invention. FIG. 4 is a view illustrating a circuitry of the dual panel apparatus in FIG. 3 according to one embodiment of the present invention.

In FIG. 3, the dual panel apparatus of the present invention includes a first panel 300, a second panel 302, a data driver 304, a first scan driving circuit 306, and a second scan driving circuit 308. Since all the elements in the second embodiment except the first panel 300 are the same as those in the first embodiment, further description concerning to the same elements will be omitted.

The first panel 300 includes first anode electrode layers and cathode electrode layers 314.

The first anode electrode layers include first sub anode electrode layers 310 and second sub anode electrode layers 312.

In addition, the first panel 300 includes first sub pixels 316 formed in cross areas of the first sub anode electrode layers 310 and the cathode electrode layers 314, and second sub pixels 318 formed in cross areas of the second sub anode electrode layers 312 and the cathode electrode layers 314. In other words, the first panel 300 of the present invention is a stack-typed panel.

Hereinafter, a stack-typed panel and a stripe-typed panel will be compared in detail.

Now referring to FIG. 1 and FIG. 3, the first panel 100 in the first embodiment is stripe-typed panel, and the first panel 300 in the second embodiment is stack-typed panel.

The number of the cathode electrode layers 314 in the first panel 300 as stack-typed panel is half than that of the cathode electrode layers 112 in the first embodiment 100 as stripe-typed panel. However, the cathode electrode layers 314 of the first panel 300 are two times wider than those of the first panel 100. In other words, the cathode electrode layers 314 of the stack-typed panel 300 are two times wider than those of the stripe-typed panel 100. As a result, the dual panel apparatus of the present invention has a circuitry as shown in FIG. 4, and the resistance of the cathode electrode layers 314 of the stack-typed panel 300 is smaller than the stripe-typed panel 100. Accordingly, the first panel 300 of the second embodiment has superior property to the first panel 100 of the first embodiment. Hence, the first panel 300 of the second embodiment is more suitable for a larger size panel.

For example, the first panel 300 as an organic electroluminescent panel is suitable for the main panel of the mobile phone. In this case, since the organic electroluminescent panel is cheaper than a liquid crystal display, the cost of the mobile phone may be reduced.

In above description, the number of the cathode electrode layers 314 in the stack-typed panel 300 is mentioned as half of the number of the cathode electrode layers 112 in the stripe-typed panel 100. However, the stack-typed panel 300 is not limited to the above method. In other words, in case that the panels 100 and 300 has the same size, for example 160 (number of pixels disposed in a longitudinal direction)×360 (number of pixels disposed in a vertical direction) size, the stack-typed panel 300 means generally as a panel where the number of cathode electrode layers 314 is smaller than that of the cathode electrode layers 112 in the stripe-typed panel 100. Accordingly, duty rate in the stack-typed panel 300 is higher than that in the stripe-typed panel 100. Here, the number of the anode electrode layers included in the stack-typed panel 300 is changed depending on that of the cathode electrode layers 314.

In a dual panel apparatus according to another embodiment of the present invention, the number of first anode electrode layers in a first panel is more than that of second anode electrode layers in a second panel.

From the preferred embodiments of the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A dual panel apparatus comprising:
a first panel configured to have first pixels;
a second panel configured to have second pixels; and
a driver coupled to the first panel and the second panel, and configured to selectively drive the first panel and the second panel.

2. The dual panel apparatus of claim 1, wherein the driver includes:
a first scan driving circuit coupled to the first panel;
a second scan driving circuit coupled to the second panel; and
a data driver coupled to the first panel and the second panel.

3. The dual panel apparatus of claim 2, wherein the first panel includes:
first anode electrode layers disposed in a first direction; and
first cathode electrode layers disposed in a second direction different from the first direction,
wherein at least one first pixel is formed in cross areas of corresponding first anode electrode layers and corresponding first cathode electrode layers,
wherein the second panel includes:
second anode electrode layers disposed in a third direction; and
second cathode electrode layers disposed in a fourth direction different from the third direction, and
wherein at least one second pixel is formed in cross areas of corresponding second anode electrode layers and corresponding second electrode layers.

4. The dual panel apparatus of claim 3, wherein the driver is coupled to at least one first anode electrode layer and at least one second anode electrode layer.

5. The dual panel apparatus for claim 2, wherein the data driver includes:
first pads coupled to the first anode electrode layers;
second pads coupled to the second anode electrode layers;
a data driving circuit configured to transmit first data signals to the first anode electrode layers through the first pads, and transmit second data signals to the second anode electrode layers through the second pads;
a first switching circuit configured to switch couple of the first pads and the data driving circuit; and
a second switching circuit configured to switch couple of the second pads and the data driving circuit.

6. The dual panel apparatus of claim 5, wherein the driver further includes:
a controller configured to transmit display data inputted from the outside to the data driving circuit; and
a switching selection circuit configured to selectively drive the switching circuits under control of the controller.

7. The dual panel apparatus of claim 6, wherein the switching selection circuit transmits a first switching signal to the first switching circuit, and transmits a second switching signal to the second switching circuit,
wherein the second switching signal and the first switching signal are inverted each other.

8. The dual panel apparatus of claim 2, wherein the data driver is located between the first panel and the second panel in view of flow of electrical signal.

9. The dual panel apparatus of claim 1, wherein at least one of the first panel and the second panel is stripe-typed panel.

10. The dual panel apparatus of claim 1, wherein at least one of the first panel and the second panel is stack-typed panel.

11. The dual panel apparatus of claim 1, wherein the second panel has a different size from the first panel.

12. The dual panel apparatus of claim 1, wherein at least one of the first panel and the second panel is organic electroluminescent panel.

13. The dual panel apparatus of claim 1, wherein the dual panel apparatus is employed for mobile phone.

14. A dual panel apparatus comprising:
first anode electrode layers disposed in a first direction;
first cathode electrode layers disposed in a second direction different from the first direction;
first pixels formed in cross areas of the first anode electrode layers and the first cathode electrode layers;
second anode electrode layers disposed in a third direction;
second cathode electrode layers disposed in a fourth direction different from the third direction;
second pixels formed in cross areas of the second anode electrode layers and the second cathode electrode layers; and
a data driver coupled selectively to the first anode electrode layers or the second anode electrode layers, and configured to transmit corresponding data signals to the coupled anode electrode layers.

15. The dual panel apparatus of claim 14, wherein at least one first anode electrode layer includes a corresponding first sub anode electrode layer and a corresponding second sub anode electrode layer.

16. The dual panel apparatus of claim 14, wherein the second cathode electrode layer has different width from the first cathode electrode layer.

17. The dual panel apparatus of claim 14, further including:
a first scan driving circuit coupled to the first cathode electrode layers, and configured to transmit first scan signals to the first cathode electrode layers;
a second scan driving circuit coupled to the second cathode electrode layers, and configured to transmit second scan signals to the second cathode electrode layers; and
a controller configured to control the data driver, the first scan driving circuit, and the second scan driving circuit.

18. A dual panel apparatus comprising:
first data lines disposed in a first direction;
first scan lines disposed in a second direction different from the first direction;
first pixels formed in cross areas of the first data lines and the first scan lines;
second data lines disposed in a third direction;
second scan lines disposed in a fourth direction different from the third direction;
second pixels formed in cross areas of the second data lines and the second scan lines;
a first scan driving circuit configured to transmit first scan signal to at least one first scan line;
a second scan driving circuit configured to transmit second scan signal to at least one scan line; and
a data driving circuit configured to provide selectively corresponding data signal to at least one first data line or at least one second data line.

19. The dual panel apparatus of claim 18, further including:
a switching selection circuit configured to switch couple of the first data line and the data driving circuit, and couple of the second data line and the data driving circuit; and
a controller configured to control the first scan driving circuit, the second scan driving circuit, the data driving circuit and, the switching selection circuit.

20. The dual panel apparatus of claim 18, wherein the resistance of the first scan line is different from that of the second scan line.
